(19) United States
(12) Patent Application Publication
(10) Pub. No.: US 2005/0210110 A1
(43) Pub. Date: Sep. 22, 2005

(54) Portable information terminal and computer software

(76) Inventor: Lijun Li, Fussa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/901,055

(22) Filed: Jul. 29, 2004

(30) Foreign Application Priority Data
Mar. 19, 2004 (JP) 2004-081050

(51) Int. Cl. G06F 15/16

(52) U.S. Cl. 709/206; 709/217

(57) ABSTRACT

A portable information terminal performs current position detection by detecting the current position of a user based on position information received from an artificial satellite and position information received from a base station; A position information URL indicative of the current position detected by the current position detection is acquired from a host computer; A processing of writing and editing mail is carried out; and the position information URL is inserted into the mail text being edited as position information, A plurality of tasks can be processed simultaneously; for example, the processing of the current position detection and the processing of the URL acquisition each consist of two or more tasks, and mail is written and edited in response to the operation of a user during the processing of these tasks.

### BACKGROUND OF THE INVENTION

The present invention relates to a portable information terminal and computer software. Specifically, it relates to a portable information terminal which can acquire position information efficiently without interrupting the editing of mail text.

Along with the spread of internet technology, information exchange of electronic mail using portable information terminals, typified by portable telephones, is becoming popular very quickly. These information terminals have a text input function for portable terminals that enables the current position of a user to be displayed on a map and to be communicated to the other party by transmitting GPS information (position information) obtained from a GPS (Global Positioning System) satellite to a host computer connected to a communication network and by downloading a map information URL (Uniform Resource Locator) showing the position information received from the host computer to attach it to the mail text (for example, JP-A 2003-14137 and JP-A2000-181814) (the term “JP-A” as used herein means an “unexamined published Japanese patent application”).

However, the above-referenced patent documents have a problem in that the mail text cannot be edited during the acquisition of the position information.

FIG. 1 shows a flowchart of the process of inserting position information using a conventional mail editing system. In FIG. 1, when an instruction is given for attaching position information to the mail text from a user while he or she is writing an electronic mail, after the process of temporarily storing a mail text being edited to save input characters is carried out (S101), the process of interrupting a character input system in operation is carried out (S102). Then, a request for the acquisition of position information is issued to the position information acquisition system (S103) to suspend operation of the mail editing system. The activated position information acquisition system carries out the process of locating the GPS (S104), the process of transmitting the result of the process of locating the GPS by activating a communication function (S105) and the process of acquiring a map information URL (S106). The position information acquisition system checks the URL information downloaded from the host computer in step S107 and issues a notice of the end of the process of acquiring position information to the mail editing system whose operation is under suspension.

Thereafter, the mail editing system stores the result of the process of acquiring position information (S108) and inserts the map information URL into the temporarily stored mail text (S109). Finally, the character input system is activated again by using an editing character string to display a character input screen again (S110), and inputting of the mail text is resumed.

In the position information acquisition system, at least processings, such as the step (S104) of locating the GPS based on position information received from an artificial satellite and position information received from a base station, the step (S105) of transmitting the result of computation obtained in the above step of locating the GPS, and the step (S106) of downloading the map information URL from the host computer are required. The above processings take several tens of seconds depending on the condition of the electric waves, and during this period, a user cannot edit (write) mail.

The present invention has solved the above-described problem, and it is an object of the present invention to provide a user-friendly portable information terminal and computer software.

### SUMMARY OF THE INVENTION

The above-stated object is attained by a portable information terminal which comprises means for carrying out parallel processing of a plurality of tasks, current position detecting means for detecting the current position of a user based on position information received from an artificial satellite and position information received from a base station, position information acquisition means for acquiring a position information URL indicative of the current position detected by the current position detecting means from a host computer connected to a communication network, and means for inserting the position information URL into the mail text being edited, wherein

when the terminal receives an instruction to insert the position information URL into the text mail being edited from the user, it issues a request for the acquisition of position information to a position information acquisition application, renews a character string each time a character is input, so as to display it in a first display area and to display information on progress in the acquisition of position information in a second display area, informs the user of the result of the process of acquiring position information at the end of the process of acquiring the position information URL and automatically inserts the position information URL into the mail text.

Further, when the position information URL is added to the mail text and the volume of the mail text exceeds a predetermined value, the insertion processing success confirming means informs the user of this condition so that the user can insert the acquired position information URL into the mail text with certainty.

That is, according to a first aspect of the present invention, there is provided a portable information terminal comprising:

current position detection means for carrying out the process of detecting the current position of a user based on position information received from an artificial satellite and position information received from a base station;

URL acquisition means for carrying out the process of acquiring a position information URL indicative of the current position detected by the current position detection means from a host computer through a communication network;

mail writing and editing means for carrying out the process of writing and editing mail in response to the operation of the user; and

mail position information inserting means for carrying out the process of inserting the position information URL into the mail text being edited as position information in response to the operation of the user, wherein

a plurality of tasks can he processed simultaneously, the current position detection processing of the current position detection means and the URL acquisition processing of the URL acquisition means each consist of two or more tasks, and the mail writing and editing means carries out the process of writing and editing mail in response to the operation of the user during the processing of these tasks.

According to a second aspect of the present invention, there is provided a portable information terminal which checks to determine if there is enough space for a position information URL in the mail text to confirm whether it is possible to insert position information into the mail text.

According to a third aspect of the present invention, there is provided a portable information terminal which issues a request for the acquisition of position information to a position information acquisition application when it receives an instruction to insert a position information URL into the mail text being edited from the user and there is enough space for position information URL.

According to a fourth aspect of the present invention, there is provided a portable information terminal which carries out the process of inputting a character and the processing of acquiring position information simultaneously and which displays a character input screen having a first display area for displaying the input character string and a second display area for displaying information on the progress in the acquisition of position information.

According to a fifth aspect of the present invention, there is provided a portable information terminal which acquires information on the progress in the renewal of a character string in the first display area every time the user inputs a character to renew the first display area.

According to a sixth aspect of the present invention, there is provided a portable information terminal which inserts a position information URL into the mail text after the end of the process of acquiring the position information URL.

According to a seventh aspect of the present invention, there is provided a portable information terminal which displays an indication that the space required for storing the position information URL is smaller than a predetermined value, if it is so, when it receives an instruction to insert the position information URL into the mail text being edited to terminate the process of acquiring the position information URL.

According to an eighth aspect of the present invention, there is provided a portable information terminal which displays an indication that the result of the process of starting the acquisition of position information is a failure, if it is so, to terminate the process of acquiring the position information URL.

According to a ninth aspect of the present invention, there is provided computer software to be used in the portable information terminal, which constitutes a program for having a computer carry out the above-described processings.

Thus, according to the present invention, a user-friendly portable information terminal can be obtained.

### BRIEF DESCRIPTION OF THE DRAWINGS

FIG. 1 is a flowchart of the conventional process of inserting position information;

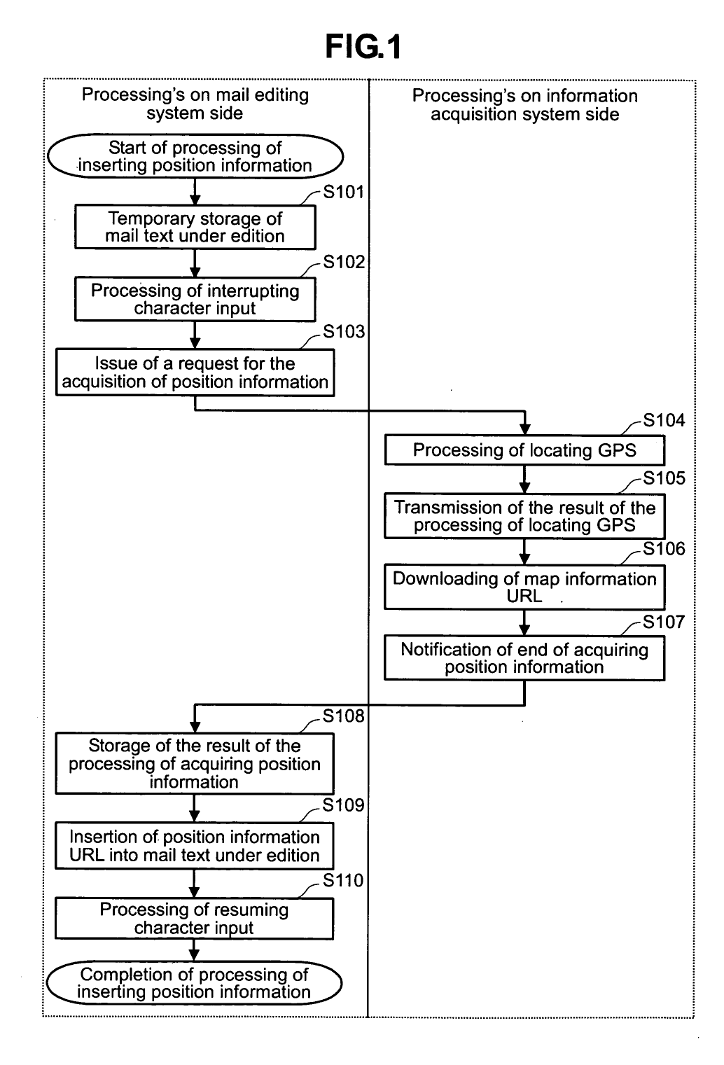

FIG. 2 is a block diagram of a mail text editing system in a portable information terminal according to an embodiment of the present invention;

FIG. 3 is a diagram showing an example of the mail text editing screen of the portable information terminal according to the present invention;

FIGS. 4(a) to 4(f) are diagrams showing information on the progress in the acquisition of position information displayed on the screen of the portable information terminal according to the present invention;

FIG. 5 is a flowchart of the process of starting the acquisition of position information in the portable information terminal according to the present invention; and

FIG. 6 is a flowchart of the process of inserting position information in the portable information terminal according to the present invention.

### DESCRIPTION OF THE PREFERRED EMBODIMENT

The best mode for carrying out the present invention will be described hereinbelow.

Embodiments of the portable information terminal and computer software of the present invention will be described with reference to the accompanying drawings.

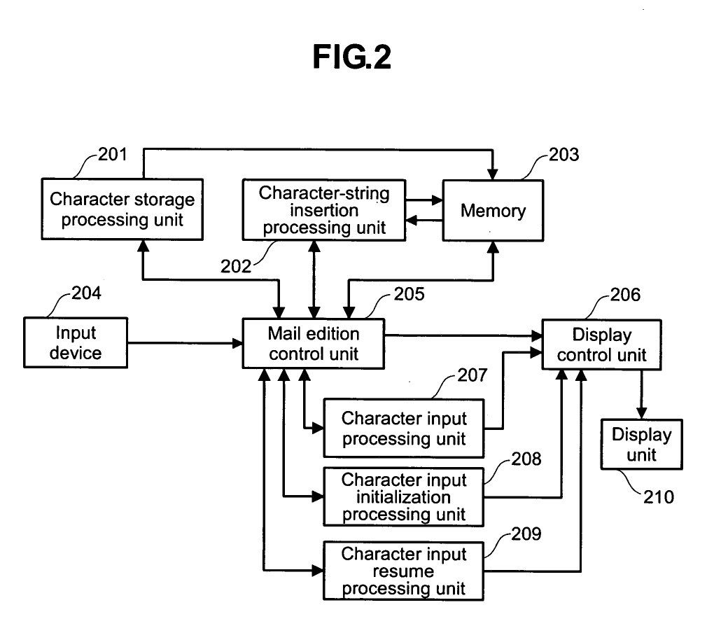

A preferred embodiment of the portable information terminal of the present invention will be described hereinbelow with reference to the accompanying drawings. FIG. 2 shows the mail text editing system of the portable information terminal of the embodiment. The mail text editing system is part of the mail system for portable information terminals, and it can create character data to create, edit and store text data when it receives the key operation of a user. As for its basic constitution, the system comprises a character storage processing unit 201, a character-string insertion processing unit 202, a memory 203, an input device 204, a mail editing control unit 205, a display control unit 206, a character input processing unit 207, a character input initialization processing unit 208, a character input resume processing unit 209 and a display unit 210.

The input device 204 comprises dial keys for inputting numbers and characters and function keys for moving a cursor and selecting a function; and, it identifies the key operation of the user, converts it into a signal able to be identified by the mail editing control unit 205 and outputs this signal. Control information from the inside of the portable information terminal is provided to the mail editing control unit 205 through the input device 204.

The mail editing control unit 205 controls the processing blocks of the mail text editing system based on the signal received from the input device 204. It also issues a request for starting information acquisition to another application when the process of acquiring information is required, based on an instruction received from the user during the editing of the mail text.

The character storage processing unit 201 stores, in the memory 203, a character string being edited in the predetermined format based on the control of the mail editing control unit 205.

The character-string insertion processing unit 202 stores a character string to be inserted that was acquired from the other application when it receives an instruction for inserting a character string from the mail editing control unit 205 and computes the length of the character string to be inserted and the space volume of the mail text being edited. When the space volume of the mail text being edited is sufficient, after the process of inserting a character string is carried out, the routine returns to the character input editing screen. When the space volume of the mail text being edited is smaller than the character string to be inserted, it is informed that the insertion of the character string is impossible and the routine returns to the character input editing screen.

The character input processing unit 207 retrieves a database and controls the display control unit 206 based on the operation content of the user communicated from the mail editing control unit 205 so as to display a character string on the display unit 210.

The character input initialization processing unit 208 controls the display control unit 206 based on the control of the mail editing control unit 205 to display the character input screen on the display unit 210.

The character input resume processing unit 209 controls the display control unit 206 based on the control of the mail editing control unit 205 to return the temporarily saved character string and character input mode so as to display the character input screen again on the display unit 210.

The memory 203 includes a storage area for the mail text and a temporary storage area for the mail text and character input mode setting parameter during the interruption of character input. Further, it comprises a temporary storage area for data required for the process of inserting a character string.

The display control unit 206 controls the display unit 210 to display a GUI (Graphical User Interface) display screen for the editing of mail based on the control by the mail editing control unit 205, the character input processing unit 207, the character input initialization processing unit 208 and the character input resume processing unit 209.

The display unit 210 is composed of a liquid crystal display, and it displays information in the form of a text or image based on the control of the display control unit 206.

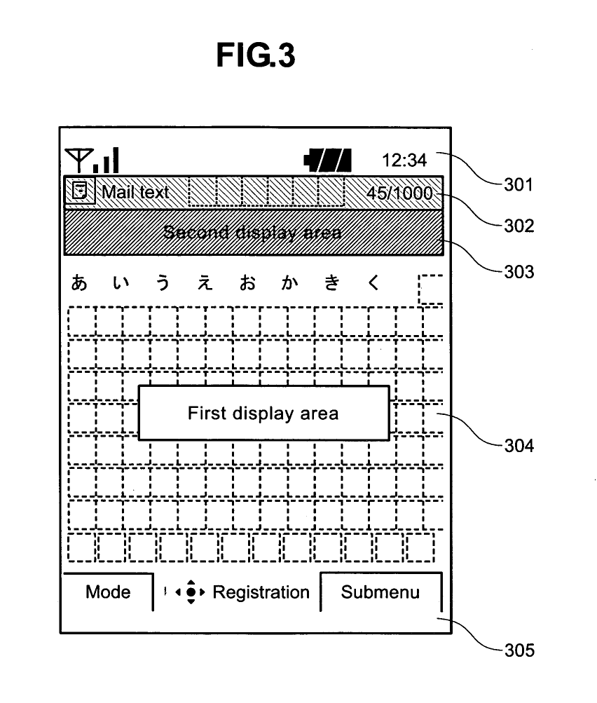

FIG. 3 shows an example of the mail text editing screen. The mail text editing screen comprises: a picked display area 301 for displaying the level of the field of electric waves, the remaining capacity of a battery and time information; a character input title display area 302 for displaying a character input title, the number of input characters and the number of characters able to be input; a settings information and position information display area (second display area) 303; a text display area (first display area) 304 for displaying a mail text to be edited; and an operation section 305 for carrying out the operations of a character input mode and a character string.

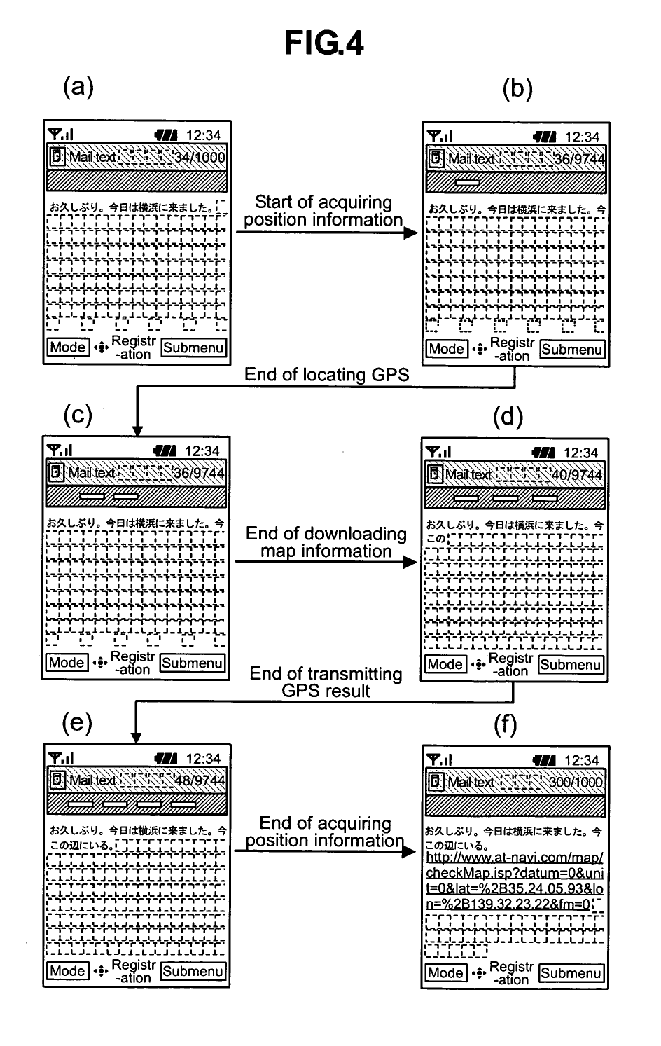

A description will be given of the operation of the terminal for the process of acquiring position information during the editing of mail text with reference to the flowchart formed by FIGS. 4a to 4f. First, when a user activates a mail function from the standby screen of his portable telephone to carry out an operation for inputting mail text, the input device 204 transmits a request for the editing of mail text to the mail text editing control unit 206. Thereafter, the mail text editing control unit 205, which has received the request, acquires an edited text storage area from the memory 203 and controls the character input initialization processing unit 208 to set the initial character input screen. The mail text editing control unit 205 informs the character input processing unit 207 of the key operation of the user from the input device 204 to create a character code based on the operation of the user. The character input processing unit 207 controls the display control unit 206 to display the input character string in the first display area 304, and then it renews the number of determined characters in the title display area 302 (see FIG. 4a).

When the user selects a position information attaching function from the submenu, the icon for the process of acquiring position information is lighted up in the second display area 303 (see FIG. 4b).

The process of acquiring position information in the portable information terminal of this embodiment consist of tasks from the start to the end of locating the GPS, the task of transmitting GPS information, the tasks from the start to the end of downloading map information, etc.; and, and there are a plurality of work areas so that the process of writing and editing mail can be carried out in response to the operation of the user during these tasks. Therefore, the display of the character string (mail text) in the first display area 304 is renewed and the display of the icon for information on the progress in the acquisition of position information in the second display area 303 is renewed by the key operation of the user after the process of lighting up the icon for the processing of acquiring position information (see FIGS. 4c to 4e). The icons for the end of locating the GPS (FIG. 4c), the end of transmitting GPS information (FIG. 4d) and the end of downloading map information (FIG. 4e) are lighted up sequentially in the order named.

Finally, the downloaded URL information is inserted into the mail text being edited to terminate the process of inserting position information (FIG. 4f).

The change of the display and the operation of the process of automatically inserting position information during the editing of the mail text in the portable information terminal of this embodiment have been outlined.

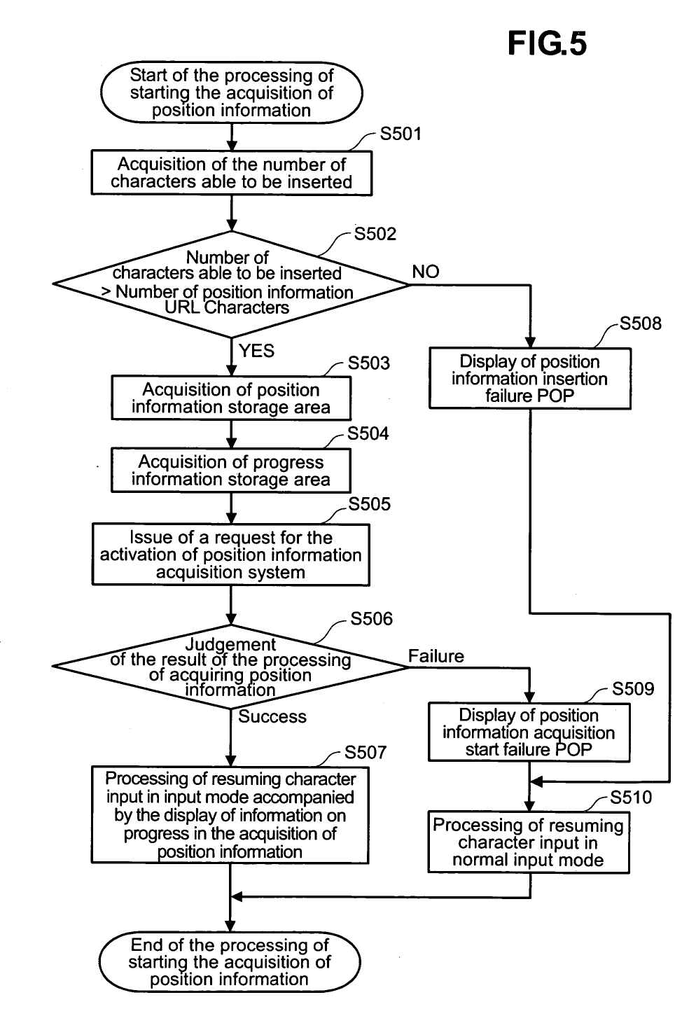

A detailed description subsequently will be given of an example of the flow of the process of starting the acquisition of position information, which is an important step for the process of automatically inserting position information, with reference to FIG. 5.

When the mail editing control unit 205 receives an instruction for the insertion of position information from the user, it acquires information on the number of characters able to be inserted from the character input processing unit (S501) to judge whether position information URL can be inserted into the mail text being edited (S502). This is intended to judge whether the processing of the URL can be inserted before the process of acquiring position information and to prevent unnecessary communication processing because the maximum number of characters able to be transmitted by mail is limited in the portable telephone. When the space volume required for automatically inserting a position information URL into the mail text being edited is sufficient, a position information storage area and a progress information storage area are acquired from the memory 203 (S503, S504) and reported to the position information acquisition system, and a start request is issued to the system (S505) to proceed to step S506.

When it is judged in step S505 that the space volume required for automatically inserting a position information URL into the mail text being edited is not sufficient, a position information insertion failure POP is displayed to inform the user (S508), and the editing of the mail text is resumed (S510).

In step S506, the result of the start processing stored in the progress information storage area by the position information acquisition system is judged. This is because, when the result of the start processing is a failure, the position information URL cannot be inserted into the mail text. When the process of starting the acquisition of position information is successful, the icon indicative of the start of acquiring position information is lighted up, an input mode accompanied by the display of progress information in the acquisition of position information is set, under the condition that the maximum number of characters able to be input is the remainder obtained by subtracting the number of input characters and the number of position information URL predetermined characters from the maximum number of characters able to be input, and then the editing of the mail text is resumed (S507).

When the process of starting the acquisition of position information is a failure in step S506, a position information acquisition start failure POP is displayed to inform the user (S509), and the editing of the mail text is resumed (S510).

The operation of the terminal for the process of starting the acquisition of position information in this embodiment has been described. Since the maximum number of characters able to be transmitted by mail is limited in a portable telephone, according to this embodiment, whether it is possible to insert URL processing is judged by the above-described process of starting the acquisition of position information before the process of acquiring position information in order to prevent unnecessary communication processing.

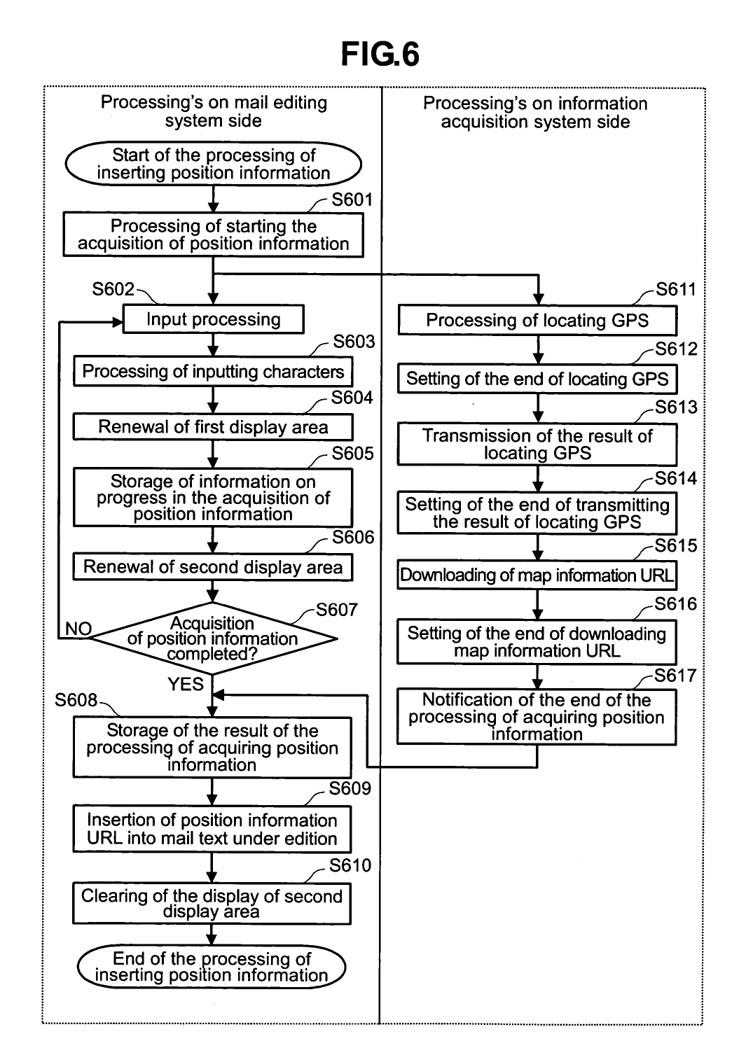

A description is subsequently given of an example of the flow of processing a character input key during the acquisition of position information and an example of the flow of processing the renewal of information on progress in the acquisition of position information, with reference to FIG. 6.

FIG. 6 is a flowchart showing an example of the flow of the process of acquiring information on the progress in the acquisition of position information and an example of a flow of the process of inserting position information in accordance with the present invention. When the mail editing control unit 205 receives an instruction for the insertion of position information, it first carries out the process of starting the acquisition of position information (S601). When it succeeds in the process of starting the acquisition of position information, it carries out the process of inputting characters in an input mode accompanied by the display of information on the progress in the acquisition of position information so that the process of acquiring position information is carried out simultaneously with the process of inputting characters.

A description will be first given of the processing flow on the mail editing system side. The mail editing control unit 205 first transmits the key operation of the user via the input device 204 to the character input processing unit 207 to proceed to step S603.

In step S603, the character input processing unit 207 edits characters based on the notice of the operation of the user and controls the display control unit 206 in step S604 to renew a character string in the first display area.

After the end of the key input operation, the mail editing control unit 205 stores information on the progress in the acquisition of position information (S605).

In step S606, the mail editing control unit 205 controls the display control unit 206 based on the progress information stored in the position information acquisition progress information storage area to light up the icon indicative of the progress information in the second display area 303 and renews the information.

Step S607 is the step of judging information on the progress in the acquisition of position information based on the renewed information.

When the processing of acquiring position information is completed, the routine proceeds to step 608 to carry out the process of inserting position information. When the process of acquiring position information is not completed, the routine returns to step S602 to carry out the processing of the next key input operation. The processings from S602 to S607 are continued until the process of acquiring position information ends.

In the position information acquisition system, the process of acquiring position information is carried out in steps S611 to S617 simultaneously with the character input processing of the mail editing system. This is because the process of acquiring position information in steps S611 to S617 consists of a plurality of tasks and the character input processing of the mail editing system can be carried out during these tasks. An example of a flow of processing of the position information acquisition system will be described hereinbelow.

Position information is first acquired from the artificial satellite and from the base station to carry out the process of locating the GPS based on position information received from the artificial satellite and position information received from the base station (S611). After the completion of the process of locating the GPS, information on the completion of locating the GPS is set in the progress information storage area communicated to the mail editing system (S612). Then, the computation result obtained by the process of locating the GPS is transmitted to the host computer connected to the communication network (S613) and information on the completion of transmitting the result of locating the GPS is set in the progress information storage area (S614). Map information URL is downloaded from the host computer and information on the completion of downloading the map information URL is set in the progress information storage area (S616). After the completion of the process of acquiring the position information URL, a notice of the end of the process of acquiring position information is issued to the mail editing system (S617) to end all of the processings on the position information acquisition system side, and then the routine proceeds to step S608 on the mail editing system side.

When the process of acquiring position information is completed, the character string insertion processing unit 202 first stores the position information URL indicating the position. The character string insertion processing unit 202 inserts the position information URL into the mail text being edited (S609) and controls the display control unit 206 to terminate the display of the character string in the first display area and the progress information in the second display area (S610).

The method of automatically inserting position information of the mail editing system in the portable information terminal of this embodiment has been described.

As described above, in this embodiment, by forming the second display area for the display of position information on the character input display screen, the user can continue to input characters while looking at information on the progress in the acquisition of position information, and so a user-friendly mail editing system can be provided.

Almost all of the processings of the portable information terminal of this embodiment can be realized by computer software.

1. A portable information terminal comprising:
current position detection means for carrying out the processing of detecting the current position of a user based on position information from an artificial satellite and position information from a base station;
URL acquisition means for carrying out the processing of acquiring position information URL indicative of the current position detected by the current position detection means from a host computer through a communication network;
mail editing means for carrying out the processing of editing a mail in response to the operation of the user; and.
mail position information inserting means for carrying out the processing of inserting position information URL into the mail text as position information under edition of the mail in response to the operation of the user, wherein
a plurality of tasks can be processed simultaneously, the current position detection processing of the current position detection means and the URL acquisition processing of the URL acquisition means each consist of two or more tasks, and the mail editing means carries out the processing of editing a mail in response to the operation of the user during the processing of these tasks.

2. The portable information terminal according to claim 1 which checks whether there is enough space for position information URL in the mail text to confirm whether it is possible to insert position information into the mail text.

3. The portable information terminal according to claim 2 which issues a request for the acquisition of position information to a position information acquisition application when it receives an instruction to insert position information URL into the mail text under edition of the mail from the user and there is enough space for position information URL.

4. The portable information terminal according to claim 3 which carries out the processing of inputting a character and the processing of acquiring position information simultaneously and displays a character input screen having a first display area for displaying the input character string and a second display area for displaying information on progress in the acquisition of position information.

5. The portable information terminal according to claim 4 which acquires information on progress of the renewal of a character string in the first display area every time the user inputs a character to renew the first display area.

6. The portable information terminal according to claim 3 which inserts position information URL into the mail text after the end of the processing of acquiring position information URL.

7. The portable information terminal according to claim 2 which displays that the space required for storing position information URL is smaller than a predetermined value if it is so when it receives an instruction to insert position information URL into the mail text under edition of the mail by a user and terminates the processing of acquiring position information URL.

8. The portable information terminal according to claim 1 which displays that the result of the processing of starting the acquisition of position information is a failure if it is so and terminates the processing of acquiring position information URL.

9. Computer software used in the portable information terminal of claim 1, the program to have a computer carry out the processing.

10. A portable information terminal having the function of detecting the current position of a user, comprising:
current position detection means for detecting the current position of the user;
URL acquisition means for acquiring position information URL indicative of the current position detected by the current position detection means from a host computer through a communication network; and
mail editing means for editing a mail in response to the operation of the user, wherein
the mail editing process can be carried out in response to the operation of the user, while the position detection means detects the current position or the URL acquisition means acquires position information URL.
